(19) United States
(12) Patent Application Publication
(10) Pub. No.: US 2013/0154871 A1
(43) Pub. Date: Jun. 20, 2013

(54) TILT SENSING SYSTEM FOR AUTOMOTIVE RADAR

(71) Applicant: Scott Howard Gaboury, Ann Arbor, MI (US)

(72) Inventor: Scott Howard Gaboury, Ann Arbor, MI (US)

(73) Assignee: FORD GLOBAL TECHNOLOGIES, LLC, DEARBORN, MI (US)

(21) Appl. No.: 13/325,085

(22) Filed: Dec. 14, 2011

(51) Int. Cl. G01S 13/00

(52) U.S. Cl. 342/82

(57) ABSTRACT

The present disclosure describes a method of aligning a forward looking radar module mounted to a vehicle. The forward looking radar module includes a radar, a tilt sensor, attached to the radar module, and a tilt sensor output. The method uses the tilt sensor output to check the radar's alignment with the vehicle's horizontal thrust direction.

### BACKGROUND

This application relates generally to the field of forward looking radar systems and, more particularly, to insuring proper physical alignment of forward looking radar systems on vehicles.

Forward looking radar systems are quite common now for vehicle features such as; adaptive cruise control, forward collision warning, and pre-crash braking To ensure proper operation, the radar must be properly aligned to the vehicle's horizontal thrust direction, and must be aligned parallel with the road surface. In addition, the vehicle must be aligned properly in relation to the road. The common solution utilizes a radar module bracket that aligns the radar to the vehicle. Such brackets may have adjustment mechanisms and in-plant assembly and service procedures developed to align the radar.

More particularly, a forward looking radar module and bracket system is in production today on several car lines. The radar sensor is mounted to body structure behind the car's front fascia and “looks” forward down the road up to 150 meters or more. The module must be physically aligned horizontal to the ground (approximately +1 degree accuracy), and parallel to the vehicles thrust axis (approximately +1 degree accuracy). In this type of radar bracket system, alignment is controlled with a sophisticated, robust, and expensive bracket system, and a post-build vehicle radar based target procedure is used to confirm proper alignment. With this type of bracket system, manual alignment changes are typically not performed online to maintain vehicle build throughput rates, although alignment service can occasionally be performed in an off-line environment is repair is required.

It would be beneficial to have a radar module that could aid in reporting its misalignment, when misalignment may occur, either during production, or after vehicle use. More particularly, it will be desirable to have an internal radar orientation measurement system that would avoid the cost, labor, throughput impact, and failure modes of using external radar alignment equipment.

### SUMMARY

One embodiment of the present application discloses a method of aligning a forward looking radar module, the forward looking radar module includes a radar, a tilt sensor, attached to the radar module, and a tilt sensor output, the method uses the radar tilt sensor output to check the radar's alignment with the vehicle horizontal thrust direction.

Certain embodiments of the present application disclose a forward looking radar module adapted to be mounted on a vehicle, the radar module includes a radar, a tilt sensor, and a controller connected to the tilt sensor to report radar tilt.

Another embodiment of the present application discloses a diagnostic system for a radar module in a vehicle. The system comprises a radar, a sensor, coupled to the radar module, continuously sensing the radar tilt as compared to the vehicle's horizontal thrust direction, and a controller configured to report radar tilt based on the input received from the sensor.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic of a tilt sensing system for an automotive radar according to the present disclosure.

FIG. 2A is a schematic of a vehicle equipped with an exemplary tilt sensing system for an automotive radar, working in an ideal condition.

FIG. 2B is a schematic of a vehicle equipped with an exemplary tilt sensing system for an automotive forward radar, with the radar tilting beyond an upper limit.

FIG. 2C is a schematic of a vehicle equipped with an exemplary tilt sensing system for an automotive forward radar, with the radar tilting beyond a lower limit.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes methods and systems for diagnosing tilts and alignments in radars mounted on vehicles. To this end, a radar module mounted in a vehicle comprises a radar, a tilt sensor employed with the radar module, and a tilt sensor output. The sensor employed is adapted to gather radar's alignment data in relation to the vehicle's horizontal thrust direction. Based on the data gathered, the controller is configured to continuously report radar tilts and misalignments, and is further enabled to switch off the radar system when the radar tilts beyond a predetermined threshold.

### Exemplary Embodiments

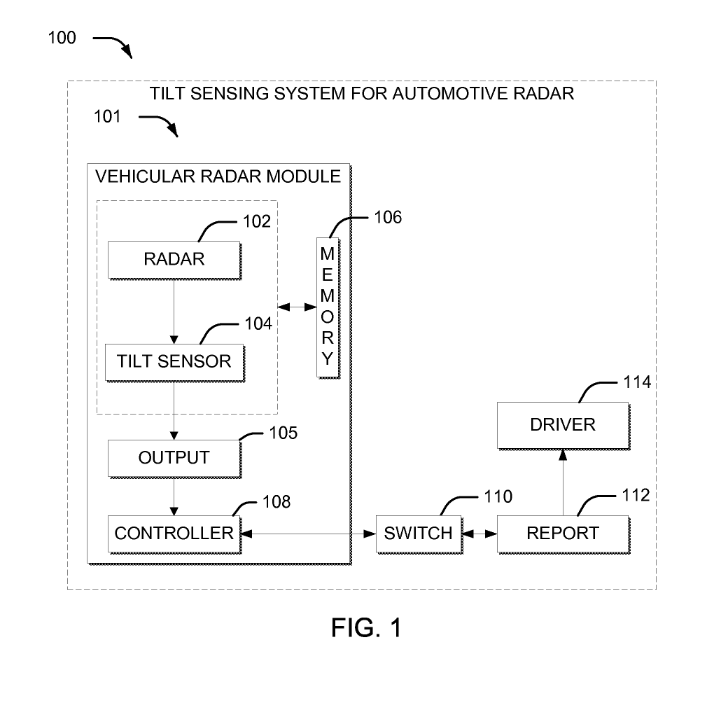

FIG. 1 illustrates an exemplary tilt sensing system 100 for an automotive radar comprising a forward looking radar module 101. The radar module 101 includes a radar 102, a tilt sensor 104 attached from within to the forward looking radar module 101, having a tilt sensor output 105, a memory device 106, and a controller 108 connected to the tilt sensor 104 to report radar tilt. The memory device 106 and controller 108 can be located either inside the radar module 101, or outside the radar module 101. The radar module 101 further comprises an on/off switch 110 to turn the radar 102 on and off, enabling the radar 102 to switch between activated and deactivated modes. A report 112 is generated by the controller 108, which can be presented to the driver 114 or recalled by a service technician, as described further below.

The radar module 101 is configured as a housing for the radar 102, the tilt sensor 104, and the controller 108, and is accordingly space efficient and compact in dimensions. The radar module 101 can thus be accommodated under the vehicle's hood, within the vehicle's front grill, or under the vehicle's front chassis.

The radar 102, housed within the radar module 101, is adapted to scan and monitor vehicles, infrastructure, and other objects, positioned in front of the driven vehicle. Such monitoring is enabled, for example, through a 75 GHz microwave beam generated by the radar 102. The radar 102 monitors all objects falling within the radar's scanning range, the beam making an angle of ±1° to the vehicle's horizontal thrust direction up to a range of 150 meters or more.

Being housed within, and coupled to the radar module 101, the tilt sensor 104 is configured to sense radar alignment, both during radar module 101 installation, as well as during vehicular movements. More particularly, the tilt sensor 104 described in the disclosure is a low-g inclinometer, that senses radar tilts and alignments in relation to the vehicle's horizontal thrust direction. One such inclinometer could be an analog device such as the ADIS16209, providing high accuracy and reliable digital operation, accomplishing both single-axis)(±180° and dual-axis)(±90° operation. Operating over a temperature range of −40° C. to +125° C., ADIS16209 can be attached internally to the radar module 101 using standard solder reflow processes.

The built-in memory device 106, in the radar module 101, is configured to store information related to radar tilt, and is coupled to the assembly of the tilt sensor 104 and the radar 102 through a cabled medium. Memory device 106 primarily comprises a single portion of a volatile memory for temporary storage of information. Alternatively, the memory device 106 may comprise multiple portions of a combination of volatile and non-volatile memories, depending upon requirements related to long-term data availability.

The controller 108, connected between the on/off switch 110 and the tilt sensor 104, is configured to form a diagnostic system, providing diagnostic information related to radar tilt during vehicular movements, through the report 112. Report 112 is generated based on radar alignment sensed by the tilt sensor 104 and provided through the output 105. The alignment information can thus be continuously checked in relation to the vehicle's horizontal thrust direction, through the controller 108. Subsequently, this report 112 can be fed to the driver 114, to a mechanic during servicing, or to an operator during the radar module 101 attachment to a vehicle. More particularly, the report 112 can be fed through a digital, analog, or LED display, or even through a register in a CPU. A vehicle occurrence that causes the radar module 101 to be improperly aligned, may initiate the controller 108 to shut down the radar 102 by operating the on/off switch 110. Improper alignment, such as noted, can be sensed by comparing a tilt value of the radar module 101 to a pre-determined threshold value. Connected to the tilt sensor 104 via cabled means, the controller 108 may be a microprocessor based control system adapted within the radar module 101. Further, the controller 108 may include appropriate input and output circuits of a known type for receiving input signals and for transmitting processed signals as outputs to certain actuators (not shown) employed therein. The actuators may in turn be configured to operate the switch 110.

During an adaptive cruise control mode, the driver 114 of a vehicle may not focus on the road conditions at all times, as one would during normal driving. During such modes, the radar 102, mounted to the vehicle continuously assists in vehicular maneuvers. Such assistance includes establishing optimized braking and acceleration patterns, depending upon the distance monitored from the surrounding traffic and infrastructure. The tilt sensor 104, being configured to sense tilt in the radar module 101 during regular periods of vehicular operation, enables the controller 108, functioning through an operational circuit, to generate diagnostic reports based on the output 105 obtained from the tilt sensor 104. Such reports, by being continuously fed to the driver 114, may form a method of aligning the forward looking radar module 101 to its original position, upon a reported misalignment. Accordingly, the driver 114 may initiate measures to align the radar module 101 through an in-vehicle interface, or by manually going under the hood of the vehicle. A mechanic, servicing the vehicle, or an operator, attaching the radar module 101 to the vehicle may also initiate similar measures upon such misalignments. Alignment of the radar module 101 may particularly include attaching the radar 102 to a vehicle using the radar tilt sensor output 105, and accordingly aligning the radar 102 with the vehicle's horizontal thrust direction. More particularly, the controller 108 functions to turn off the radar 102 when the radar module 101 tilts beyond a pre-determined threshold. In another embodiment, the controller 108 could be configured to generate audible or visual warnings, or alarms upon such reported deviations in the radar module 101.

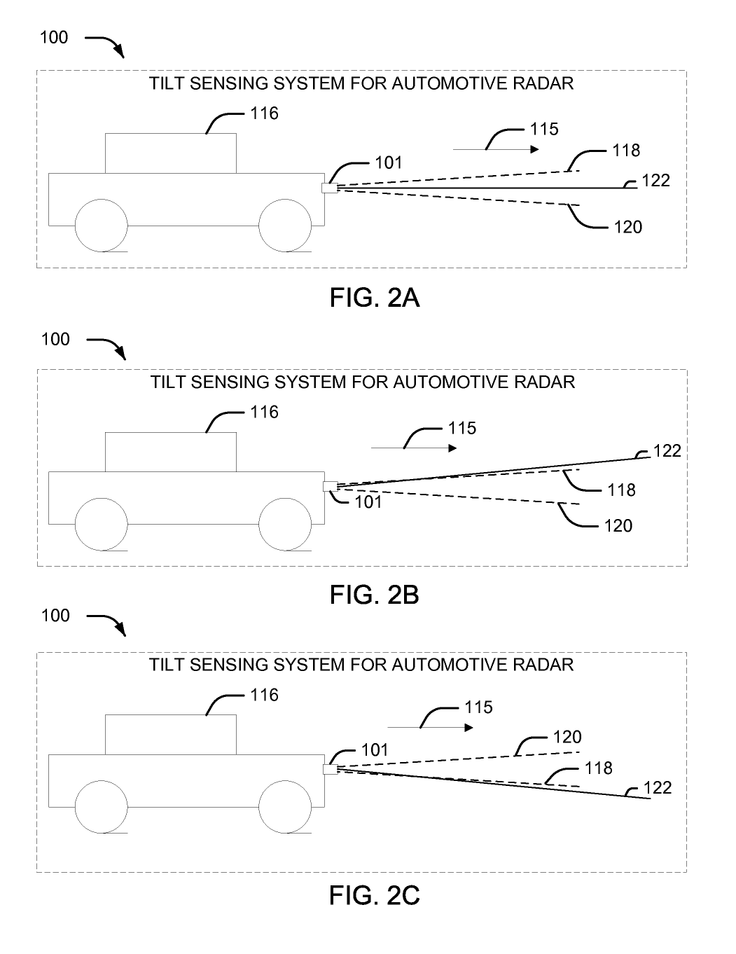

FIG. 2A depicts the tilt sensing system 100 applied in a vehicle 116, with the vehicle 116 operating in the adaptive cruise control mode. This method employs attaching the tilt sensor 104 to the radar module 101 and using the radar tilt sensor output 105 to sense and check continuously the radar's alignment with the vehicle's horizontal thrust direction. The tilt sensing system 100, comprising the radar module 101, is employed within the vehicle's front grill as shown. The radar 102 housed in the radar module 101 maintains optimal monitoring of the surrounding vehicles and infrastructure by maintaining a radar beam 122 parallel to the vehicle's forward thrust direction 115 as shown by the arrow. Importantly, the figure depicts an upper beam limit 118 and a lower beam limit 120, both lying symmetrically opposite to the radar beam 122.

The upper beam limit 118 and the lower beam limit 120 are primarily the predetermined thresholds beyond which the functioning of the radar beam 122 during an adaptive cruise control mode becomes ineffective.

As disclosed in FIG. 1, sensing and reporting of the radar's alignment to the vehicle's forward thrust direction 115 is performed continuously through the tilt sensor 104 and the controller 108, respectively.

FIG. 2B depicts the condition when a tilt in radar module 101 has caused the radar beam 122 to have deviated beyond the upper beam limit 118. Similarly, FIG. 2C depicts the condition when a tilt in radar module 101 has caused the radar beam 122 to have deviated beyond the lower beam limit 120.

Both the above noted conditions of the radar beam 122 deviating beyond the upper beam limit 118 and the lower beam limit 120, respectively, are deemed insecure and inappropriate for effective vehicular operation during an adaptive cruise control mode. Such conditions upon being sensed through the tilt sensor 104, signals the controller 108 through the output 105 to report the radar tilt, and further deactivates the radar 102 through the on/off switch 110.

It will be understood that the incorporation of sensors such as inclinometers, as disclosed, or other tilt sensitive sensors in radar systems employed within a vehicle, configured to diagnose positional information of the forward looking radar module 101 and/or radar 102, would fall under the scope of the present disclosure.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A method of aligning a forward looking radar module, the forward looking radar module including:
a radar;
a tilt sensor, and
a tilt sensor output,
the method comprising:
using the radar tilt sensor output to check the radar's alignment with the vehicle's horizontal thrust direction.

2. The method of claim 1, wherein the method further includes the step of:
using the radar tilt sensor output to continuously check the radar's alignment with the vehicle's horizontal thrust direction.

3. The method of claim 1 further includes attaching the radar to a vehicle using the radar tilt sensor output by aligning the radar with the vehicle's horizontal thrust direction.

4. The method of claim 1, wherein the tilt sensor is a low-g inclinometer.

5. The method of claim 1 further comprising an on/off switch to turn the radar on and off.

6. The method of claim 5, wherein a controller is connected between the on/off switch and the tilt sensor, and operates to turn off the radar when the radar module tilts beyond a pre-determined threshold.

7. A forward looking radar module adapted to be mounted on a vehicle, the radar module comprising:
a radar;
a tilt sensor; and
a controller connected to the tilt sensor to report radar tilt.

8. The radar module according to claim 7, wherein the tilt sensor is a low-g inclinometer.

9. The radar module according to claim 7 further comprising an on/off switch to turn the radar on and off.

10. The radar module according to claim 9, wherein the controller is connected between the on/off switch and the tilt sensor, and operates to turn off the radar when the radar module tilts beyond a pre-determined threshold.

11. A diagnostic system for a radar module in a vehicle, the system comprising:
a radar;
a sensor, coupled to the radar module, to continuously sense radar tilt as compared to the vehicle's horizontal thrust direction; and
a controller configured to report radar tilt based on an output received from the sensor.

12. The system of claim 11 further comprising an on/off switch to turn the radar on and off.

13. The system of claim 12, wherein the controller is connected between the on/off switch and the sensor, and operating to turn off the system when the radar module tilts beyond a pre-determined threshold.

14. The system of claim 11, wherein the sensor is a low-g inclinometer.

15. The system of claim 11, wherein the radar module is a forward looking radar module.

16. The system of claim 11, wherein the controller reports the radar tilt through at least one of:
a digital display;
an analog display; and
a cpu register.
